(19) United States
(12) Patent Application Publication
(10) Pub. No.: US 2025/0033190 A1
(43) Pub. Date: Jan. 30, 2025

(54) ELASTIC STRUCTURE-BASED DEVICE SUPPORTING HUMAN BODY ACTIVITY AND ITS CONTROL METHOD

(71) Applicant: Electronics and Telecommunications Research Institute, Daejeon (KR)

(72) Inventor: Ho Chul SHIN, Daejeon (KR)

(21) Appl. No.: 18/784,844

(22) Filed: Jul. 25, 2024

(30) Foreign Application Priority Data
Jul. 25, 2023 (KR) 10-2023-0097018

(51) Int. Cl. B25J 9/00; B25J 9/10

(52) U.S. Cl. CPC B25J 9/0006; B25J 9/104

(57) ABSTRACT

Disclosed are devices, systems, and control methods based on elastic structures that support human activities. According to an embodiment of the present disclosure, a device based on an elastic structure that supports human activities may include a plurality of straps attached to a user's body; a first elastic frame coupled to the user's body through a first strap coupled to each of the user's left and right shoulder regions among the plurality of straps and a second strap coupled to the user's waist region; a second elastic frame attached to the user's body through the second strap among the plurality of straps and a third strap attached to the left and right knee areas of the user.

### CROSS-REFERENCE TO RELATED APPLICATIONS

This application claims the benefit of earlier filing date and right of priority to Korean Application No. 10-2023-0097018, filed on Jul. 25, 2023, the contents of which are all hereby incorporated by reference herein in their entirety.

### TECHNICAL FIELD

The present disclosure relates to the field of wearable devices, and more specifically, to a device based on an elastic structure that supports human activities and a method of controlling the same.

### BACKGROUND

The wearable device/robot industry has recently been in the spotlight as a technology-intensive industry that requires a lot of research and costs to secure stability and precise control capabilities. In addition, macroscopic changes in population structure due to aging are increasing the demand and need for research and development of wearable devices/robots that require muscle assistance.

Technology that supports human body activities using exoskeleton robots in the wearable device/robot field is a technology for wearable devices/robots equipped with actuators that support human joints by combining human intelligence and machine power, and is used in many fields, including rehabilitation applications.

Meanwhile, to support human body activities in general, exoskeleton robots and soft suits require individual actuators, reducers, and batteries linked to each movement to support specific movements. However, there is a problem that the weight of individual actuators, reducers, and batteries linked to each operation may impede cost, efficiency, and user convenience.

### SUMMARY

The technical problem of the present disclosure is to provide a device based on an elastic structure that supports human activities and a method for controlling the same.

The technical object of the present disclosure is to provide a device that assists the movement of the human body using an elastic frame and a wire actuator and a method of controlling the same.

The technical problems to be achieved in the present disclosure are not limited to the technical tasks mentioned above, and other technical problems not mentioned will be clearly understood by those skilled in the art from the description below.

As an example of the present disclosure, a device based on an elastic structure that supports human activities may include a plurality of straps attached to a user's body; a first elastic frame coupled to the user's body through a first strap coupled to each of the user's left and right shoulder regions among the plurality of straps and a second strap coupled to the user's waist region; a second elastic frame attached to the user's body through the second strap among the plurality of straps and a third strap attached to the left and right knee areas of the user; a first elastic wire connecting both end points where the first elastic frame is attached to the first strap; and a second elastic wire connecting both end points where the second elastic frame is attached to the second strap; and a third elastic wire connected to the first elastic frame and the second elastic frame.

In addition, based on the user being in a standing position, the first elastic wire, the second elastic wire, and the third elastic wire are relaxed, based on the user moving from a standing position to a sitting position, the first elastic wire, the second elastic wire, and the third elastic wire are contracted, and based on the user's movement from a sitting position to a standing position, the first elastic wire and the second elastic wire are relaxed and the third elastic wire is contracted.

In addition, the device may include a first wire actuator attached to a lower region of the first elastic frame and controlling the first elastic wire; a second wire actuator attached to an upper region of the second elastic frame and controlling the second elastic wire; a third wire actuator controlling the second elastic wire; and at least one tension sensor that detect tension of each of the first elastic wire, the second elastic wire, and the third elastic wire; and a control module for controlling the first wire actuator, the second wire actuator, and the third wire actuator.

In addition, each of the first strap, the second strap, and the third strap includes at least one of an acceleration sensor, an inertial sensor, or an electromyography (EMG) sensor, and the control module may be configured to: predict movement of the user based on information obtained through at least one of the acceleration sensor, inertial sensor, EMG sensor, or tension sensor, based on the predicted user's movement, generate driving force profile information including i) an operation to be performed by each of the first wire actuator, the second wire actuator, and the third wire actuator and ii) a size of driving force to be distributed to each of the first wire actuator, the second wire actuator, and the third wire actuator, and control the first wire actuator, the second wire actuator, and the third wire actuator based on the driving force profile information.

In addition, the control module may be configured to: based on the user assuming a sitting posture during a first time period, control the first wire actuator to contract the first elastic wire, control the second wire actuator to relax the second elastic wire, and control the third wire actuator so that the third elastic wire is contracted.

In addition, the control module maybe configured to: based on an input of a signal requesting that the user is in a standing posture or does not restrict movement during a second time period, control the first wire actuator, the second wire actuator, and the third wire actuator so that the first elastic wire, the second elastic wire, and the third elastic wire are relaxed.

In addition, the control module may be configured to: based on the user's posture of lifting a specific object, control the first wire actuator to relax the first elastic wire, and control the second wire actuator and the second wire actuator to contract the second elastic wire and the third elastic wire.

In addition, the plurality of straps may include a fourth strap attached to the user's thigh area and a fifth strap attached to the user's shin area, and the device further may include a fourth elastic frame coupled to a thigh region of the user's body through the fourth strap; a fifth elastic frame attached to the user's shin area through the fifth strap; a fourth elastic wire connecting both end points where the fourth elastic frame is attached to the fourth strap; and a fifth elastic frame including the fifth elastic wire connecting both end points at which the fifth elastic frame is attached to the fifth strap.

In addition, each of the first elastic frame and the second elastic frame may include a plurality of sub-elastic frames having a left-right symmetrical structure.

According to another embodiment of the present disclosure, a method of controlling a device based on an elastic structure that supports human activity may include predicting a user's movement based on data obtained through at least one sensor and at least one tension sensor included in a plurality of straps attached to the user's body; based on the predicted user's movement, generating driving force profile information including an operation to be performed by each of a plurality of wire actuators and a size of driving force to be distributed to the plurality of wire actuators; and controlling each of the plurality of wire actuators based on the driving force profile information, and the plurality of straps may include a first strap attached to each of the user's left and right shoulder areas, a second strap attached to the user's waist area, and a third strap attached to the user's left and right knee areas, a first elastic frame may be attached to the user's body through the first strap and the second strap, a second elastic frame may be attached to the user's body through the second strap and the third strap, a first elastic wire may be connected to both end points where the first elastic frame is attached to the first strap, a second elastic wire may be connected to both end points where the second elastic frame is attached to the second strap, and a third elastic wire may be connected to the first elastic frame and the second elastic frame.

In addition, based on the user being in a sitting position during a first time period: the first wire actuator may be controlled to retract the first elastic wire, the second wire actuator may be controlled to relax the second elastic wire, and the third wire driver may be controlled to contract the third elastic wire.

In addition, based on an input of a signal requesting that the user is in a standing posture or does not restrict movement during a second time period, control the first wire actuator, the second wire actuator, and the third wire actuator so that the first elastic wire, the second elastic wire, and the third elastic wire may be relaxed.

based on the user's posture of lifting a specific object, the first wire driver is controlled to relax the first elastic wire, and the second wire driver and the second wire driver are controlled to contract the second elastic wire and the third elastic wire.

In addition, each of the first elastic frame and the second elastic frame may include a plurality of sub-elastic frames having a left-right symmetrical structure.

According to another embodiment of the present disclosure, an elastic structure-based system that supports human activity may include a control module; and a support device comprising a plurality of straps, a plurality of elastic frames, a plurality of wire actuators, and a plurality of elastic wires coupled to a user's body, and the control module may be configured to: predict a user's movement based on data obtained through at least one sensor and at least one tension sensor included in a plurality of straps attached to the user's body; based on the predicted user's movement, generate driving force profile information including an operation to be performed by each of a plurality of wire actuators and a size of driving force to be distributed to the plurality of wire actuators; and control each of the plurality of wire actuators based on the driving force profile information, and the plurality of straps include a first strap attached to each of the user's left and right shoulder areas, a second strap attached to the user's waist area, and a third strap attached to the user's left and right knee areas, and the plurality of elastic frames include: a first elastic frame attached to the user's body through the first strap and the second strap; and a second elastic frame attached to the user's body through the second strap and the third strap, and the plurality of elastic wires may include: a first elastic wire connected to both end points where the first elastic frame is attached to the first strap; a second elastic wire connected to both end points where the second elastic frame is attached to the second strap; and a third elastic wire connected to the first elastic frame and the second elastic frame.

The features briefly summarized above with respect to the disclosure are merely exemplary aspects of the detailed description of the disclosure that follows, and do not limit the scope of the disclosure.

According to various embodiments of the present disclosure, a device based on an elastic structure that supports human activity and a control method thereof may be provided.

According to various embodiments of the present disclosure, a device and a control method for assisting the movement of the human body using an elastic frame and a wire actuator may be provided.

According to various embodiments of the present disclosure, users can perform physical activities more safely by using the assistive force provided by the elastic frame and wire actuator at work sites, rehabilitation treatment, living support environments for the elderly, and leisure/sports activities.

The effects obtainable in the present disclosure are not limited to the effects mentioned above, and other effects not mentioned will be clearly understood by those skilled in the art from the description below.

### BRIEF DESCRIPTION OF THE DRAWINGS

The accompanying drawings included as part of the detailed description to facilitate understanding of the present disclosure provide embodiments of the present disclosure and describe technical features of the present disclosure along with detailed descriptions.

FIG. 1 is a flowchart for describing a control method of a device based on an elastic structure that supports human activity, according to an embodiment of the present disclosure.

FIG. 2 is a diagram illustrating a device based on an elastic structure that supports human activity, according to an embodiment of the present disclosure.

FIG. 3, FIG. 4A, FIG. 4B and FIG. 4C are diagrams for describing a method of supporting a user's squat movement through wire actuator control, according to an embodiment of the present disclosure.

FIG. 5 is a diagram for describing a method of assisting a user in lifting a heavy object, according to an embodiment of the present disclosure.

FIG. 6 is a diagram for describing a method for assisting the posture of a user sitting on a chair, according to an embodiment of the present disclosure.

FIG. 7 is a diagram illustrating a method of controlling a device so as not to impose restrictions on a user's activities, according to an embodiment of the present disclosure.

FIG. 8 is a diagram illustrating the configuration of a module for selective support of up, down, left, and right directions based on the user, according to an embodiment of the present disclosure.

FIG. 9 is a diagram illustrating the configuration of multiple frames to increase the degree of control freedom, according to an embodiment of the present disclosure.

FIG. 10A, FIG. 10B, and FIG. 10C illustrate an elastic frame wire configuration for supporting lower extremity assistive forces, according to one embodiment of the present disclosure.

FIG. 11A and FIG. 11B are a block diagram illustrating the configuration of a control module that controls a device that selectively supports user activities according to an embodiment of the present disclosure.

FIGS. 12 and 13 are diagrams for describing the structure of an elastic structure device for supporting human activity composed of a passive structure, according to an embodiment of the present disclosure.

FIGS. 14 and 15 are diagrams to describe a device based on an elastic structure that supports human activities.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In this disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

The system and/or method/device (hereinafter simply referred to as ‘system’) proposed in the present disclosure relates to technology for supporting human body activities using an elastic frame and wire actuator.

Specifically, a plurality of elastic frames including one or more wire actuators and driving force sensors may be attached to the body through a strap with a built-in sensor. One or more wire actuators may control tension by pulling or releasing the wire.

For example, if support is needed for standing activities, etc. as the wires are wound or unwound by the wire actuator, the plurality of frames may be deformed, and as a result, standing force and support may be provided to the user through straps attached to the human body. In addition, one or more driving wires extend inside the fastening strap, so the fastening force of the human body can be improved through the tensile force of the wire.

As an example of the present disclosure, the device may predict the motion of the human body using information from one or more sensors built into the strap for controlling the wire actuator (e.g., EMG (electromyography), inertial sensor, etc.) and the tension sensor of the wire actuator, and may classify the predicted human body motion.

Additionally, the device may determine information on assisting force/driving force to be provided based on the predicted/classified motion and determine driving force distribution according to the deployed actuator. The device may generate a driving force profile for the distributed driving force and control the wire actuator using the generated driving force profile and information from the actuator tension sensor.

Hereinafter, a device based on an elastic structure that supports human activity and its control method will be described in more detail.

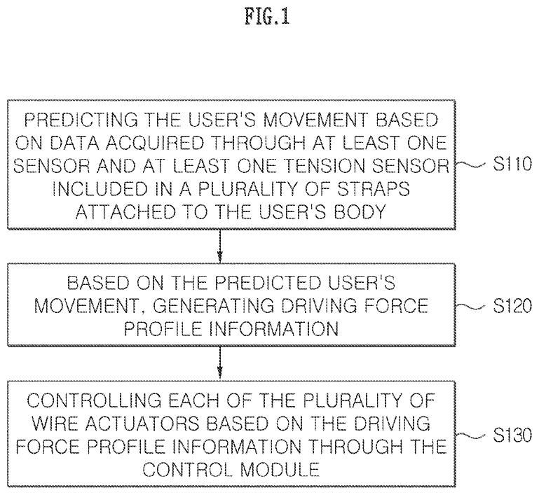

FIG. 1 is a flowchart for explaining a control method of a device based on an elastic structure that supports human activity, according to an embodiment of the present disclosure.

In describing the present disclosure, a device based on an elastic structure may include a plurality of straps, a plurality of elastic frames, a plurality of elastic wires, a plurality of wire actuators, and a control module.

That is, a plurality of straps, a plurality of elastic frames, a plurality of elastic wires, a plurality of wire actuators, and a control module may be combined to form an elastic structure-based device that supports human body activities, and the device may refer to a wearable device that a user can wear.

The device may predict the user's movement based on data acquired through at least one sensor and at least one tension sensor included in a plurality of straps attached to the user's body (S110).

Here, the strap may be attached to the user's body, and the elastic frame, wire actuator, and elastic wire may be attached to the body through the strap. The strap may include one or more sensors. As an example, the strap may include at least one of an acceleration sensor, an inertial sensor, or an electromyography (EMG) sensor.

As an example, the plurality of straps may include at least one of a first strap attached to each of the user's left and right shoulder areas, a second strap attached to the user's waist area, a third strap attached to the user's left and right knee areas, a fourth strap attached to the user's thigh area, and a fifth strap attached to the user's shin area.

The device may obtain data related to the user's movement based on at least one of an acceleration sensor, an inertial sensor, an EMG sensor, and a tension sensor. The device may predict the movement of the user's premises based on the acquired data related to the user's movement.

Based on the predicted user's movement, the device may generate driving force profile information including the operation to be performed by each of the plurality of wire actuators and the size of the driving force to be distributed to the plurality of wire actuators (S120).

That is, the device may generate driving force profile information including the operation to be performed by each of the plurality of wire actuators and the size of the driving force to be distributed to the plurality of wire actuators based on the predicted user's movement through the control module.

Specifically, a first elastic frame (i.e., upper elastic frame) may be attached to the user's body through the first strap and the second strap, and a second elastic frame (i.e., lower elastic frame) may be attached to the user's body through the second strap and third strap.

A first elastic wire (i.e., an elastic wire connected to the upper elastic frame) may be connected to both end points where the first elastic frame is attached to the first strap. A second elastic wire (i.e., an elastic wire connected to the lower elastic frame) may be connected to both end points where the second elastic frame is attached to the second strap. And, a third elastic wire (i.e., a wire connected to the middle actuator and a pulley) may be connected to the first elastic frame and the second elastic frame.

And, the plurality of wire actuators may include a first wire actuator (i.e., top actuator) attached to the bottom region of the first elastic frame and controlling the first elastic wire, a second wire actuator (i.e., bottom actuator) attached to the upper region of the second elastic frame and controlling the second elastic wire, and a third wire actuator (interrupted actuator) that controls the second elastic wire.

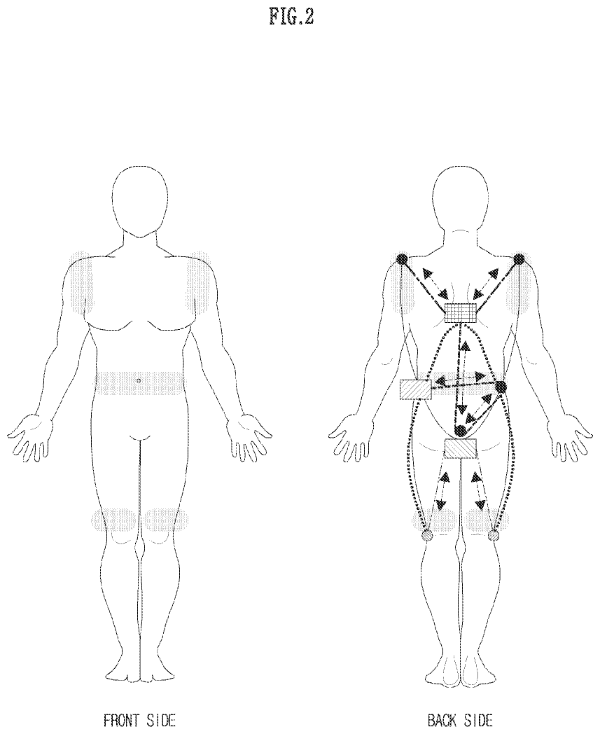

Here, the first elastic frame may be configured in a U-shape or V-shape, as shown in FIG. 2. Accordingly, both end points of the first elastic frame may mean both ends of a U or V shape, and the lower area of the first elastic frame may mean a vertex portion of a U or V shape.

And, as shown in FIG. 2, the second elastic frame may be configured in the form of an inverted U or V shape. Therefore, the both end points of the first elastic frame may refer to both end points when the U or V shape is placed upside down, and the upper area of the second elastic frame may refer to the vertex of a U or V shape when placed upside down.

Additionally or alternatively, each of the first elastic frame and the second elastic frame may be comprised of a plurality of sub-elastic frames. That is, the first elastic frame and the second elastic frame may be configured in a plurality of segmented forms.

As an example, the first elastic frame may be composed of a first sub-elastic frame and a second sub-elastic frame having a left-right symmetrical structure. Here, both end points of the first elastic frame refer to points where each of the first sub-elastic frame and the second sub-elastic frame are attached to the strap.

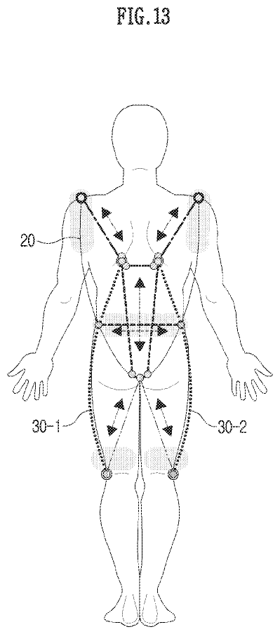

Additionally, the second elastic frame may be composed of a third sub-elastic frame and a fourth sub-elastic frame having a left-right symmetrical structure. At this time, both end points of the second elastic frame refer to points where each of the third sub-elastic frame and the fourth sub-elastic frame are attached to the strap. In FIG. 13, an embodiment in which the second elastic frame is segmented into two sub-elastic frames having left and right symmetrical structures will be described. The driving force profile information may include an operation to be performed by each of the plurality of wire actuators (e.g., whether to enter the contracted state by pulling the elastic wire or to enter the relaxed state by releasing the elastic wire, etc.) and the size of the driving force to be distributed to the plurality of wire actuators.

The device may control each of the plurality of wire actuators based on the driving force profile information through the control module (S130).

As an example of the present disclosure, based on predicting/identifying that the user is in a sitting position during the first time period, the device may control the first wire actuator to contract the first elastic wire, control the second wire actuator to relax the second elastic wire, and control the third wire actuator to contract the third elastic wire.

Specifically, the device may predict that the user adopts a sitting posture during the first time period through data acquired through each sensor. The device may control each actuator according to driving force profile information obtained based on the predicted user's posture.

Accordingly, the elastic restoring force of the second elastic frame is provided to the user, by contracting the second wire actuator and the third wire actuator, a standing force may be provided to the user's torso. The second wire actuator may maintain a relaxed state to release pressure on the user's lower extremities. In addition, the second and third wire actuators for the second elastic frame may provide a tensile force to support the weight of the user's upper body and provide an assistive force for standing the trunk.

Another example of the present disclosure, based on the input of a signal requesting that the user not assume a standing posture or restrict movement during the second time period, the device may control the first wire actuator, the second wire actuator, and the third wire actuator so that the first elastic wire, the second elastic wire, and the third elastic wire are relaxed.

That is, the device may determine that the user wishes to assume a standing posture or not impose any restrictions on movement during the second time period (e.g., if the user is in a low squat during the second time period). At this time, the device may ensure a gap between the plurality of elastic frames and the corresponding straps by maximally relaxing each elastic wire. Accordingly, there may be no restrictions on the user's activities.

As another example of the present disclosure, based on the user assuming a posture of lifting a specific object, the device may control the first wire actuator to relax the first elastic wire, and the second wire actuator and the second wire actuator may be controlled to contract the second elastic wire and the third elastic wire.

Specifically, the device may identify a situation in which the user is lifting a heavy object through one or more sensors included in the strap and one or more tension sensors. At this time, the first wire actuator of the device may relax and the second and third wire actuators may contract to the maximum. Accordingly, as an upward assisting force is applied to the user's lower extremities and torso, the user can lift a specific object more efficiently.

As an example of the present disclosure, the user's knee extension and extension movements may be supported through the fifth elastic frame coupled to the user's shin area through a fourth elastic frame and a fifth strap coupled to the thigh region of the user's body via the fourth strap.

For example, the user's knee extension and extension movements may be supported through a fourth elastic wire connecting both end points where the fourth elastic frame is attached to the fourth strap and a fifth elastic wire connecting both end points where the fifth elastic frame is attached to the fifth strap.

As another example of the present disclosure, a device based on an elastic structure that supports human activity may be composed of only a plurality of elastic frames and a plurality of elastic wires. In other words, an auxiliary force that assists the user's activities may be generated and applied only by the elastic force generated by each elastic frame and elastic wire.

For example, when the user is in a standing position, the first elastic wire, the second elastic wire, and the third elastic wire may be relaxed. Based on the user's movement from a standing position to a sitting position, the first elastic wire, second elastic wire, and third elastic wire connected to each elastic frame may contract. Based on the user's movement from a sitting position to a standing position, the first elastic wire and the second elastic wire may relax and the third elastic wire may contract.

As another example of the present disclosure, based on a user's movement from a standing position to a sitting position, the device may detect the corresponding movement of the user through one or more sensors and a tension sensor included in the strap. The device may obtain the operation of each actuator and the driving force to be distributed according to the detected movement. That is, the device may control a plurality of wire actuators so that the first elastic wire, the second elastic wire, and the third elastic wire are contracted.

And, based on the user's movement from a sitting position to a standing position, the device may detect the corresponding movement of the user through one or more sensors and tension sensors included in the strap. The device may obtain the operation of each actuator and the driving force to be distributed according to the detected movement. That is, the device may control the plurality of wire actuators so that the first elastic wire and the second elastic wire are relaxed and the third elastic wire is contracted.

FIG. 2 is a diagram illustrating a device based on an elastic structure that supports human activity, according to an embodiment of the present disclosure.

As shown in FIG. 2, a user may wear a strap 10 with a built-in sensor. The strap 10 with a built-in sensor can be worn around the user's shoulders, abdomen, and knees, but is not limited thereto. The strap 10 may be worn on a specific part of the user's body to fasten each frame, actuator, and wire to the body.

A plurality of elastic frames (e.g., an upper elastic frame 20 and a lower elastic frame 30) may be attached to the user's body through a strap with a built-in sensor. A wire actuator and an actuator sensor may be attached to each of the plurality of elastic frames.

For example, the lower actuator 40 may be attached to the lower part of the upper frame 20, and the upper actuator 50 may be attached to the upper part of the lower frame 30. The upper frame 20 and the lower frame 30 may each have a middle actuator 60 coupled to each other. The top actuator 50 may be connected to the upper end of the upper frame 20 through an elastic wire, and the lower actuator 40 may be connected to the lower end of the lower frame 30 through an elastic wire. The middle actuator 60 may be connected with an elastic wire via the upper frame 20 and the lower frame 30 via a pulley. Each actuator may control the tension force by pulling or releasing the connected wire.

FIG. 4A, FIG. 4B and FIG. 4C are a diagram illustrating a method of supporting a user's squat movement through wire actuator control, according to an embodiment of the present disclosure.

As an example, assume that the user moves from a standing state as shown in FIG. 4A to a sitting state as shown in FIG. 4B. Here, the upper actuator, the middle actuator, and the lower actuator are controlled to be in a relaxed state by unwinding the wire, so as not to interfere with the user's operation.

It is assumed that the user moves from a sitting state as shown in FIG. 4B to a standing state as shown in of FIG. 4C. At this time, the upper actuator, the middle actuator, and the lower actuator may all provide trunk standing force to the user by contracting the wire.

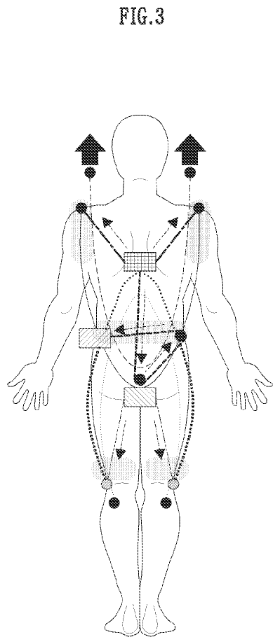

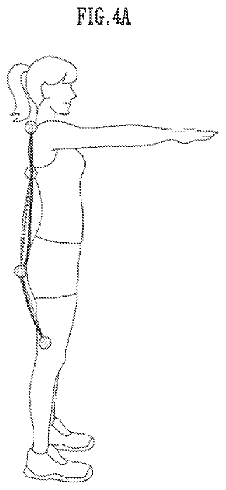

And, as shown in FIG. 4C, when the user approaches the standing posture, the upper actuator and the lower actuator unwind the wire and control it to be in a relaxed state and the mid-actuator may provide trunk standing force to the user by maintaining a contracted state. That is, as shown in FIG. 3, the upper frame extends upward and the lower frame extends downward, so that upward standing force and downward support force can be provided to the user.

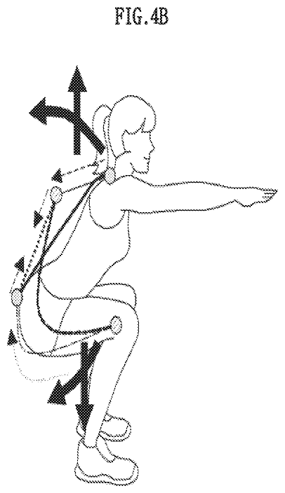

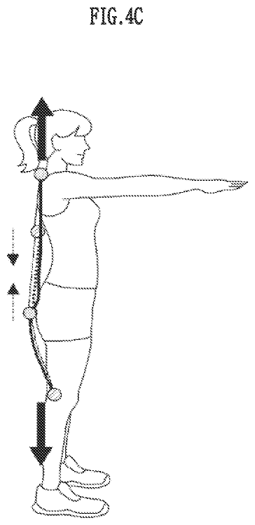

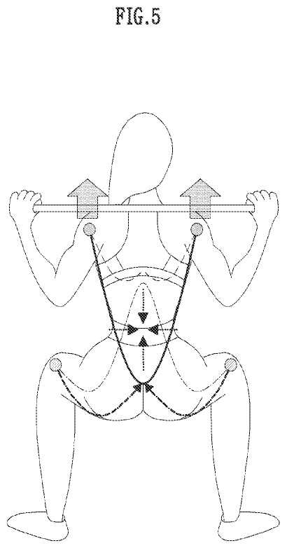

FIG. 5 is a diagram for describing a method of assisting a user in lifting a heavy object, according to an embodiment of the present disclosure.

Assistive force for the user's lifting a heavy object (for example, lifting a specific object at a work site, etc.) can be supported through the contraction and relaxation motion of each actuator.

As an example, as shown in FIG. 5, When the user tries to get up from a low position, The top actuator may be relaxed by unwinding the wire, while the middle and bottom actuators can be retracted by pulling the wire. Depending on the control of each actuator, an upward assistive force may be applied to the user's lower extremities and torso, and thus assistive force may be provided for the user's lifting a heavy object.

That is, when the upper actuator enters the relaxed state and the middle and lower actuators enter the contracted state, the upward assisting force generated acts when the user lifts a heavy object, thereby reducing the user's risk of injury.

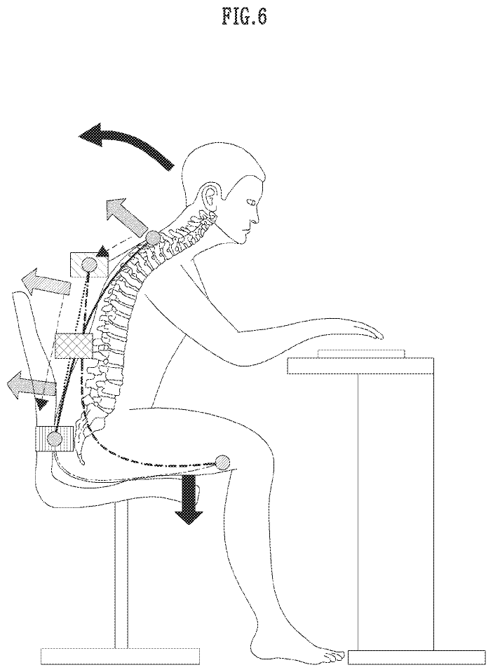

FIG. 6 is a diagram for describing a method for assisting the posture of a user sitting on a chair, according to an embodiment of the present disclosure.

As an example, as shown in FIG. 6, if the user is sitting on a chair, an elastic restoring force of the lower frame may be provided, and a standing force for the user's torso may be provided as the middle actuator and the upper actuator retract.

In addition, the lower actuator releases pressure on the user's lower extremities by maintaining a relaxed state, and the middle actuator and the upper actuator may provide a tensioning force to the lower frame, thereby supporting the weight of the user's upper body or providing an assistive force for erecting the torso.

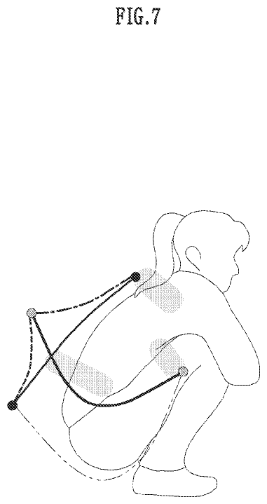

FIG. 7 is a diagram illustrating a method of controlling a device so as not to impose restrictions on a user's activities, according to an embodiment of the present disclosure. Specifically, FIG. 7 is a diagram for describing how the actuator is controlled so as not to disturb the user's low squat state (i.e., the state in which the user is in a low posture to perform a squat movement).

When the user is in a low squat position, the top actuator, middle actuator, and bottom actuator may all maintain maximum relaxation. Specifically, the top actuator, the middle actuator, and the bottom actuator are controlled to maximize the relaxation of the wire, so that each actuator can all maintain the maximum relaxation state.

At this time, as the clearance between the plurality of frames (i.e., the upper frame and the lower frame) and the body attachment strap is secured, restrictions may not be placed on the user's current posture.

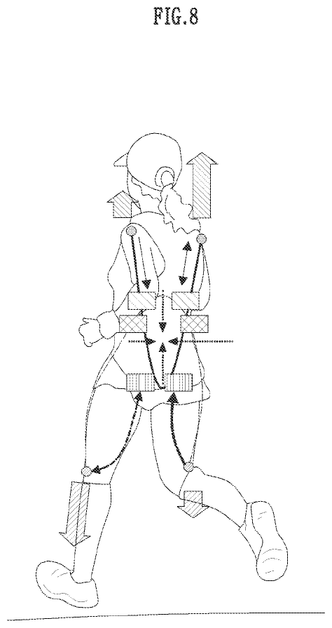

FIG. 8 is a diagram illustrating the configuration of a module for selective support of up, down, left, and right directions based on the user, according to an embodiment of the present disclosure.

FIG. 8 is a diagram illustrating the configuration of a module for selective support of up, down, left, and right directions based on the user, according to an embodiment of the present disclosure.

The two top actuators, the middle actuator, and the bottom actuators may each individually pull or unwind the wire. For example, when a user performs a walking or running motion, the upper actuator, middle actuator, and lower actuator disposed on the left and right sides may alternately switch to a contracted/relaxed state. Accordingly, assistive power required by the user can be selectively supported.

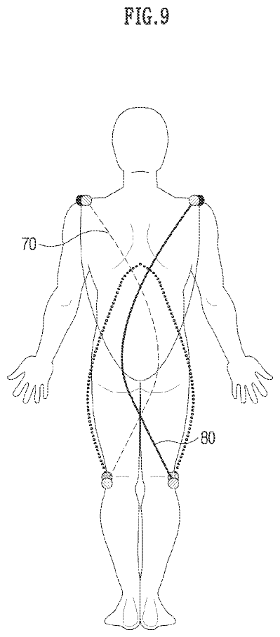

FIG. 9 is a diagram illustrating the configuration of multiple frames to increase the degree of control freedom, according to an embodiment of the present disclosure.

For example, if the user's limbs and trunk require detailed activity support, a left frame 70 and a right frame 80 can be added. That is, as the left frame 70 and the right frame 80 are additionally attached to the body through straps, the degree of freedom of control of each actuator and frame can be increased.

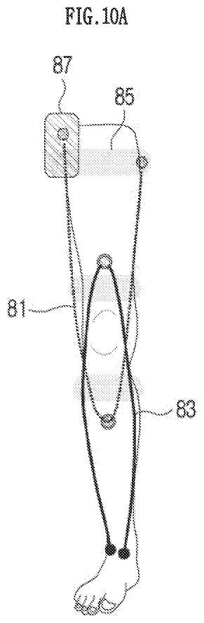

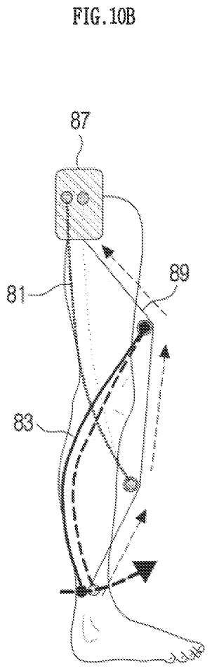

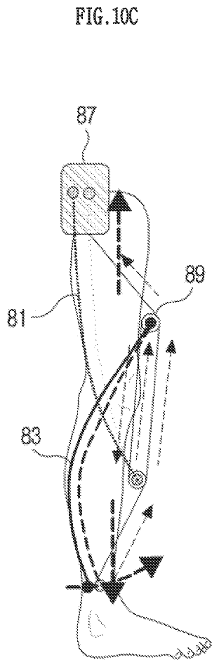

FIG. 10A, FIG. 10B, and FIG. 10C illustrate an elastic frame wire configuration for supporting lower extremity assistive forces, according to one embodiment of the present disclosure.

As an example, as shown in FIG. 10A, in order to provide assistive force to the lower extremities, by attaching the thigh frame 81 and the shin frame 83 to the body through the strap 85 and controlling the lower limb assistance force transmission wire through the wire actuator 87, Lower extremity assistive forces may be provided.

As an example, FIG. 10B is a diagram for describing a method of supporting a knee extension motion through a wire actuator, and FIG. 10C is a diagram for describing a method of supporting the extension and extension movements of the knee through a wire actuator.

When constructing the elastic frame and wire actuator 87 as shown in FIG. 10A and arranging the wire 89 as shown in FIG. 10B, the tensile force according to the wire actuator 87 is transmitted to the ankle, thereby supporting the shin motion of the lower extremity.

And, when the wire 89 is disposed through the thigh frame 81 and the shin frame 83 as shown in FIG. 10C, rotational force corresponding to the stretching force and stretching force in the vertical direction may be additionally supported.

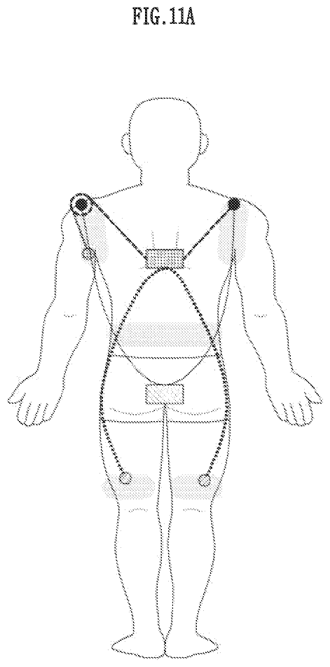

FIG. 11A and FIG. 11B are a diagram for describing the structure of an elastic wire extension strap for adjusting the fastening force of the human body, according to an embodiment of the present disclosure.

As an example, as shown in FIG. 11A and FIG. 11B, an elastic wire connected to an actuator for transmitting tensile force may extend inside the fastening strap.

Here, when a tensile force is applied to the elastic wire by the actuator, the fastening force of the strap may automatically increase. Also, when the device is in a relaxed state by controlling the actuator, the fastening force of the strap is lowered and thus may not cause discomfort to the user.

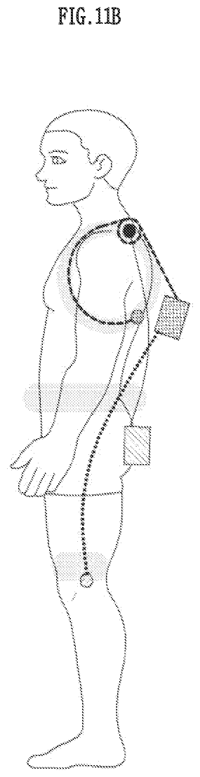

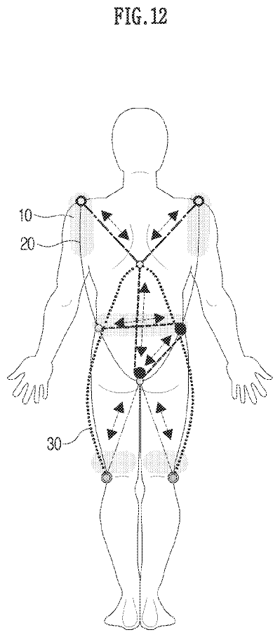

FIG. 12 is a diagram illustrating a device based on an elastic structure that supports human activity and is composed of a passive structure, according to an embodiment of the present disclosure.

As shown in FIG. 12, devices based on elastic structures that support human activities may include a strap 10, an upper elastic frame 20, and a lower elastic frame 30, similar to the device shown in FIG. 1, but may not include a separate wire actuator. In other words, a device based on an elastic structure that supports human activity can be controlled through elastic force according to a wire connected to the upper elastic frame 20 and the lower elastic frame 30.

For example, when a user wearing the device moves, the wire may contract or relax depending on the user's movement.

As an example, when the user is standing, a first elastic wire connected to the upper elastic frame 20, a second elastic wire connected to the lower elastic frame 20, and a third elastic wire connected to the upper elastic frame 20 and the lower elastic frame 30 may be relaxed.

Based on the user's movement from a standing position to a sitting position, the first elastic wire, the second elastic wire, and the third elastic wire may be retracted.

And, based on the user's movement from a sitting position to a standing position, the first elastic wire and the second elastic wire may relax and the third elastic wire may contract.

FIG. 13 is a diagram illustrating a device based on an elastic structure supporting human body activities composed of a passive structure of the present disclosure.

As shown in FIG. 13, Bottom elastic frame of a device supporting human activity consisting of a passive structure may include a first sub-lower elastic frame 30-1 and a second sub-lower elastic frame 30-2 having a left-right symmetrical shape.

As the lower elastic frame is composed of sub-elastic frames 30-1 and 30-2 having left and right symmetrical shapes, the degree of freedom can be increased. Each sub-elastic frame 30-1 and 30-2 having a left and right symmetrical shape may be connected to an upper elastic wire connected to each of the straps attached to the user's left and right knees.

FIG. 13 shows a case where the lower elastic frame is composed of two segments, but it is not limited thereto and may be composed of more than two segments. In addition, of course, the upper elastic frame 20 may also be composed of two or more segments.

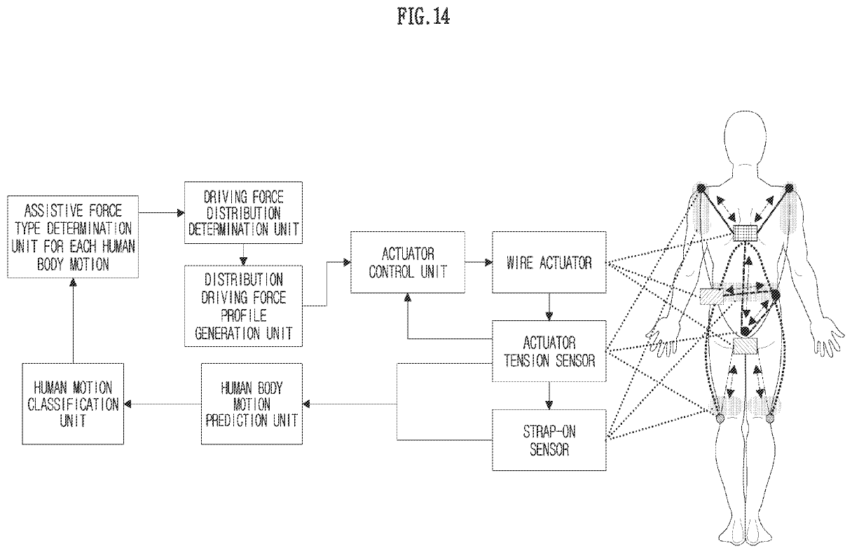

FIG. 14 is a diagram for describing the structure of an elastic structural device for supporting human activity, according to an embodiment of the present disclosure.

A device (or system) that supports human activity may include an assistive force type determination unit for each human body motion (or assistive force type judgment module for each human motion), human motion classification unit (or human motion classification module), driving force distribution determination unit (or driving force distribution judgment module), distribution driving force profile generation unit (or distribution driving force profile generation module), human body motion prediction unit (or human body motion prediction module) and actuator control unit (or actuator control module), wire actuator, actuator tension sensor, and strap-on sensor (e.g. EMG, inertial sensor, etc.).

The human body motion prediction unit may obtain/generate prediction information about the motion the user wants to perform based on sensing data acquired through a strap-embedded sensor and tension information acquired through an actuator tension sensor.

The human motion classification unit may classify the motion that the user wants to perform based on the prediction information generated/obtained by the human motion prediction unit. In other words, the human motion classification unit may identify the type of motion that the user wants to perform.

THE assistive force type determination unit for each human body motion may determine the type of assisting force corresponding to the type of motion the user wants to perform (that is, the type of assisting force needed to assist the motion the user wants to perform).

In order to apply the assistive force determined by the assistive force type judgment unit for each human body motion to the user, The driving force distribution determination unit may determine the driving force (i.e., auxiliary force) to be distributed to each of the one or more actuators connected by the strap.

The distribution driving force profile generation unit may generate a profile for the driving force determined/distributed by the driving force distribution determination unit and transmit the generated profile to the actuator control unit. Here, the profile may include the driving force distribution result, information about the actuator that will apply the driving force, information on the user's motion to be assisted according to the action of the distributed driving force, etc.

The actuator control unit may control the wire actuator based on the profile generated by the distributed driving force profile generator and the tension information generated by the actuator tension sensor. In other words, the actuator control unit may provide auxiliary force to assist the user's actions by controlling the wire actuator.

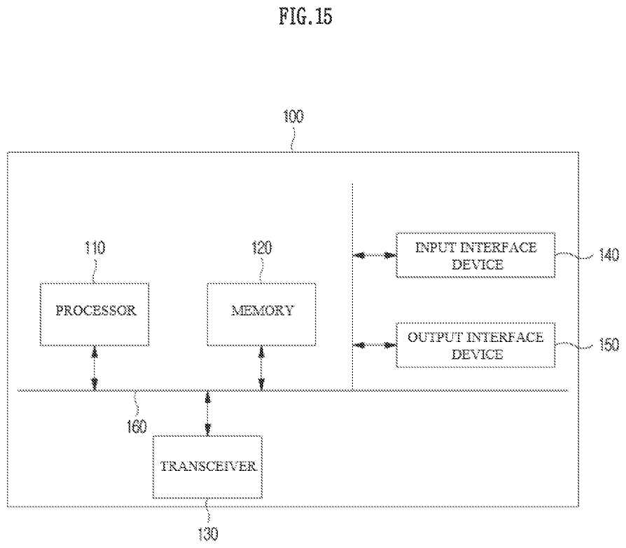

FIG. 15 is a block diagram illustrating the configuration of a control module for controlling a device based on an elastic structure that supports human activity.

A device based on an elastic structure that supports human activity may provide a user with a tensile force generated by controlling a drive wire. Accordingly, the user can be provided with assistance for his or her movements.

For example, the device may include a control module 100, a body attachment strap with an embedded sensor, an upper actuator, a middle actuator, a lower actuator, elastic wires and/or pulleys connected to each actuator, an upper elastic frame, a lower elastic frame, etc. The control module 100 may remove separate support devices (e.g., sensors, wire actuators, elastic wires, etc.) included in the device or predict the user's actions.

The control module 100 may include at least one of a processor 110, a memory 120, a transceiver 130, an input interface device 140, and an output interface device 150. Each component is connected by a common bus 160 and can communicate with each other. Additionally, each component may be connected through an individual interface or individual bus centered on the processor 110, rather than through the common bus 160.

The processor 110 may be implemented in various types such as an Application Processor (AP), Central Processing Unit (CPU), Graphic Processing Unit (GPU), etc. and may be any semiconductor device that executes instructions stored in the memory 120. The processor 110 may execute program commands stored in the memory 120. The processor 110 may be set to perform the method of controlling a device based on an elastic structure that supports human activities described above based on FIGS. 1 to 14.

The processor 110 may control an assistive force type judgment unit for each human body motion included in the device, human motion classification unit, driving force distribution determination unit, distribution driving force profile generation unit, human motion prediction unit, actuator control unit, a wire actuator, an actuator tension sensor, and a strap built-in sensor.

And/or, the processor 110 may store program instructions for implementing at least one function for one or more modules in the memory 120 and control the operations described based on FIGS. 1 to 14 to be performed. That is, each operation and/or function according to FIGS. 1 to 14 may be executed by one or more processors 110.

Memory 120 may include various types of volatile or non-volatile storage media. For example, the memory 120 may include read-only memory (ROM) and random access memory (RAM). In an embodiment of the present disclosure, the memory 120 may be located inside or outside the processor 110, and the memory 120 may be connected to the processor 110 through various known means.

For example, the memory 120 may store information related to the user's motion predicted by the human body motion prediction unit. The memory 120 may store the results determined by the assistance force type determination unit and the driving force distribution determination unit for each human body motion.

The transmitting and receiving unit 130 may perform a function of transmitting and receiving data processed/to be processed by the processor 110 with an external device and/or an external system.

For example, the transceiver 130 may be used to exchange data with other terminal devices.

The input interface device 140 may be configured to provide data to the processor 110.

The output interface device 150 may be configured to output data from the processor 110.

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that this disclosure include all other substitutions, modifications and variations falling within the scope of the following claims.

What is claimed is:

1. A device based on an elastic structure that supports human activities, the device comprising:
a plurality of straps attached to a user's body;
a first elastic frame coupled to the user's body through a first strap coupled to each of the user's left and right shoulder regions among the plurality of straps and a second strap coupled to the user's waist region;
a second elastic frame attached to the user's body through the second strap among the plurality of straps and a third strap attached to the left and right knee areas of the user;
a first elastic wire connecting both end points where the first elastic frame is attached to the first strap; and
a second elastic wire connecting both end points where the second elastic frame is attached to the second strap; and
a third elastic wire connected to the first elastic frame and the second elastic frame.

2. The device of claim 1, wherein:
based on the user being in a standing position, the first elastic wire, the second elastic wire, and the third elastic wire are relaxed,
based on the user moving from a standing position to a sitting position, the first elastic wire, the second elastic wire, and the third elastic wire are contracted, and
based on the user's movement from a sitting position to a standing position, the first elastic wire and the second elastic wire are relaxed and the third elastic wire is contracted.

3. The device of claim 1, further comprising:
a first wire actuator attached to a lower region of the first elastic frame and controlling the first elastic wire;
a second wire actuator attached to an upper region of the second elastic frame and controlling the second elastic wire;
a third wire actuator controlling the second elastic wire; and
at least one tension sensor that detect tension of each of the first elastic wire, the second elastic wire, and the third elastic wire; and
a control module for controlling the first wire actuator, the second wire actuator, and the third wire actuator.

4. The device of claim 3, wherein:
each of the first strap, the second strap, and the third strap includes at least one of an acceleration sensor, an inertial sensor, or an electromyography (EMG) sensor, and
the control module is configured to:
predict movement of the user based on information obtained through at least one of the acceleration sensor, inertial sensor, EMG sensor, or tension sensor,
based on the predicted user's movement, generate driving force profile information including i) an operation to be performed by each of the first wire actuator, the second wire actuator, and the third wire actuator and ii) a size of driving force to be distributed to each of the first wire actuator, the second wire actuator, and the third wire actuator, and
control the first wire actuator, the second wire actuator, and the third wire actuator based on the driving force profile information.

5. The device of claim 4, wherein:
the control module is configured to:
based on the user assuming a sitting posture during a first time period, control the first wire actuator to contract the first elastic wire, control the second wire actuator to relax the second elastic wire, and control the third wire actuator so that the third elastic wire is contracted.

6. The device of claim 4, wherein:
the control module is configured to:
based on an input of a signal requesting that the user is not in a standing posture or does not restrict movement during a second time period, control the first wire actuator, the second wire actuator, and the third wire actuator so that the first elastic wire, the second elastic wire, and the third elastic wire are relaxed.

7. The device of claim 4, wherein:
the control module is configured to:
based on the user's posture of lifting a specific object, control the first wire actuator to relax the first elastic wire, and control the second wire actuator and the second wire actuator to contract the second elastic wire and the third elastic wire.

8. The device of claim 1, wherein:
the plurality of straps include a fourth strap attached to the user's thigh area and a fifth strap attached to the user's shin area, and
further comprising:
a fourth elastic frame coupled to a thigh region of the user's body through the fourth strap;
a fifth elastic frame attached to the user's shin area through the fifth strap;
a fourth elastic wire connecting both end points where the fourth elastic frame is attached to the fourth strap; and
a fifth elastic frame including the fifth elastic wire connecting both end points at which the fifth elastic frame is attached to the fifth strap.

9. The device of claim 1, wherein:
each of the first elastic frame and the second elastic frame includes a plurality of sub-elastic frames having a left-right symmetrical structure.

10. A method of controlling a device based on an elastic structure that supports human activity, the method comprising:
predicting a user's movement based on data obtained through at least one sensor and at least one tension sensor included in a plurality of straps attached to the user's body;
based on the predicted user's movement, generating driving force profile information including an operation to be performed by each of a plurality of wire actuators and a size of driving force to be distributed to the plurality of wire actuators; and
controlling each of the plurality of wire actuators based on the driving force profile information,
wherein the plurality of straps include a first strap attached to each of the user's left and right shoulder areas, a second strap attached to the user's waist area, and a third strap attached to the user's left and right knee areas,
wherein a first elastic frame is attached to the user's body through the first strap and the second strap,
wherein a second elastic frame is attached to the user's body through the second strap and the third strap,
wherein a first elastic wire is connected to both end points where the first elastic frame is attached to the first strap,
wherein a second elastic wire is connected to both end points where the second elastic frame is attached to the second strap, and
wherein a third elastic wire is connected to the first elastic frame and the second elastic frame.

11. The method of claim 10, wherein:
the plurality of wire actuators includes:
a first wire actuator attached to a lower region of the first elastic frame and control the first elastic wire;
a second wire actuator attached to an upper region of the second elastic frame and control the second elastic wire; and
a third wire actuator that controls the second elastic wire.

12. The method of claim 11, wherein:
based on the user being in a sitting position during a first time period:
the first wire actuator is controlled to retract the first elastic wire,
the second wire actuator is controlled to relax the second elastic wire, and
the third wire actuator is controlled to contract the third elastic wire.

13. The method of claim 11, wherein:
based on an input of a signal requesting that the user is not in a standing posture or does not restrict movement during a second time period, control the first wire actuator, the second wire actuator, and the third wire actuator so that the first elastic wire, the second elastic wire, and the third elastic wire are relaxed.

14. The method of claim 11, wherein:
based on the user's posture of lifting a specific object, the first wire actuator is controlled to relax the first elastic wire, and the second wire actuator and the second wire actuator are controlled to contract the second elastic wire and the third elastic wire.

15. The method of claim 10, wherein:
the plurality of straps include a fourth strap attached to the user's thigh area and a fifth strap attached to the user's shin area, and
the device further includes:
a fourth elastic frame coupled to a thigh region of the user's body through the fourth strap;
a fifth elastic frame attached to the user's shin area through the fifth strap;
a fourth elastic wire connecting both end points where the fourth elastic frame is attached to the fourth strap; and
a fifth elastic frame including the fifth elastic wire connecting both end points at which the fifth elastic frame is attached to the fifth strap.

16. The method of claim 10, wherein:
each of the first elastic frame and the second elastic frame includes a plurality of sub-elastic frames having a left-right symmetrical structure.

17. An elastic structure-based system that supports human activity, the system comprising:
a control module; and
a support device comprising a plurality of straps, a plurality of elastic frames, a plurality of wire actuators, and a plurality of elastic wires coupled to a user's body,
wherein the control module is configured to:
predict a user's movement based on data obtained through at least one sensor and at least one tension sensor included in a plurality of straps attached to the user's body;
based on the predicted user's movement, generate driving force profile information including an operation to be performed by each of a plurality of wire actuators and a size of driving force to be distributed to the plurality of wire actuators; and
control each of the plurality of wire actuators based on the driving force profile information,
wherein the plurality of straps include a first strap attached to each of the user's left and right shoulder areas, a second strap attached to the user's waist area, and a third strap attached to the user's left and right knee areas,
wherein the plurality of elastic frames include:
a first elastic frame attached to the user's body through the first strap and the second strap; and
a second elastic frame attached to the user's body through the second strap and the third strap,
wherein the plurality of elastic wires include:
a first elastic wire connected to both end points where the first elastic frame is attached to the first strap;
a second elastic wire connected to both end points where the second elastic frame is attached to the second strap; and
a third elastic wire connected to the first elastic frame and the second elastic frame.
